(19) United States
(12) Patent Application Publication
(10) Pub. No.: US 2008/0260315 A1
(43) Pub. Date: Oct. 23, 2008

(54) Rolling Mechanism for Supporting Very Large Maximum Loads

(76) Inventor: Marin Clausin, Villerville (FR)

Correspondence Address: BROWDY AND NEIMARK, P.L.L.C.;624 NINTH STREET, NW, SUITE 300, WASHINGTON, DC, 20001-5303, US

(21) Appl. No.: 12/089,175

(22) PCT Filed: Oct. 3, 2006
(86) PCT No.: PCT/FR2006/002237

§ 371 Date: Apr. 3, 2008

(30) Foreign Application Priority Data
Oct. 3, 2005 (FR) 0510069
Nov. 10, 2005 (FR) 0511431

(51) Int. Cl. F16C 33/62; F16C 33/58; F16C 33/34; F16C 33/32

(52) U.S. Cl. 384/492; 384/569; 384/565; 384/490

(57) ABSTRACT

The inventive rolling mechanism brings into play two pieces (1, ST) that rotate relative to one another with the interposition of rolling elements (5) supporting on raceways (4a, S2) facing the two pieces (1, ST) with a bearing that is exerted on respective contact surfaces of said raceways (4a, S₂) and said rolling elements (5). At least one of the contact surfaces (S₂) carries a layer (C) made of a material that is harder and more resistant than the underlying substrate that supports it.

The present invention relates to a rolling/bearing device intended to withstand very significant maximum loads, and however having very low mass.

It is more particularly applied in fields where a low mass is primordial, including in chemically aggressive environments or in salt mists.

In particular, it is especially advantageously suitable in the field of fittings for high performance ships, and notably for making a pulley with a toric hole passing through its center, by means of which this pulley may be attached by a rope passing through it.

Traditionally, rolling bearings supporting small loads or even medium loads include balls which are generally in steel or even in certain cases in aluminium alloy or in ceramic.

When the loads increase, traditionally, the bearings used comprise needles.

Generally, a roller or needle which has a contact generatrix when it rolls, is called a needle. Balls as for them only have one contact point. A roller with a length at least equal to its diameter and rolling on a generatrix will be called a needle herein. In the following description, the term “rolling means” will be used for designating balls, needles or equivalent means, indistinctly.

Hitherto, rolling bearings supporting strong loads comprised hard steel needles because hard steel provides mechanical characteristics compatible with the mechanical characteristics required for providing proper operation. It was obvious to those skilled in the art that the use of other softer materials such as mild steel, stainless steels, aluminium alloys, titanium, . . . is unsuitable for making needle bearings which have to accept strong loads.

Unfortunately, hard steels are heavy and not very resistant to external aggressive a(gents such as salt mists and therefore cannot be used in many fields where both of these additional characteristics are primordial.

Making bearings using titanium, either for making the balls, or for making the rolling/bearing surfaces, has already been proposed. These solutions are only suitable when radial forces are not very significant. If the contact pressure exceeds a threshold, the ball will tend to be crushed and the rolling/bearing surface will tend to be deformed by punching.

This is the reason why one skilled in the art will spontaneously discard this solution for making pulleys intended to receive very significant radial forces of the order of about five tons, for a pulley mass of the order of about 300 grams.

The object of the present invention is to find a remedy to these drawbacks by proposing a solution especially well adapted to the making of a rolling bearing which has to withstand significant loads for a minimum mass in a chemically aggressive atmosphere.

For this purpose, it proposes a rolling/bearing device which involves two parts which are rotationally mobile relatively to each other with interposition of rolling members bearing upon rolling paths facing both parts with pressure which is exerted at the respective contact surfaces of said paths and said rolling members.

According to the invention, this device is characterized in that at least one of said contact surfaces bears a layer in a harder and more resistant material than the underlying substrate which supports it.

As an example, the substrate bearing the aforementioned layer may be made in titanium whereas the layer may be made in a material such as titanium nitride which has greater hardness than titanium but however has a much lower friction coefficient than the latter. Lightening of the device is thereby achieved while increasing the performances of the device.

Indeed, by this arrangement, the layer in a harder material provides distribution of the forces exerted by the contact surface which will press against it, over an area of the substrate of a larger size. Consequently, the compressive stress exerted on the substrate is reduced so as to remain above the residual deformation threshold, and a reduction of the punching effect and of the friction forces which result therefrom, is obtained, greatly superior to the expected results.

It is found that surprisingly, this result is particularly apparent when needle bearings are used preferably to ball bearings. The obtained result and in particular the reduction of the punching effect, are greatly superior to the expected results.

According to a particularly advantageous embodiment of the invention, the rolling/bearing device comprises an assembly of needles placed between a fixed portion having at least one axisymmetrical toric or cylindrical external rolling/bearing surface and a mobile portion having at least one axisymmetrical toric or cylindrical internal rolling/bearing surface.

Advantageously, the rolling/bearing device described earlier may form a high performance pulley for sailing boats or the like where the exerted forces are very large and where it is desirable to reduce the masses of the pulley and its bulkiness while observing operational constraints.

This pulley of general toric shape may comprise:
a guide component having al axisymmetrical shape and including an outer groove intended for guiding a rope and an inner surface comprising a first rolling path,
a ring-shaped supporting structure on which the guide component is rotatably mounted, this supporting structure being made by assembling two respectively right and left coaxial inner axisymmetrical parts,
a rolling and connecting ring comprising:
   on the outside, an axisymmetrical cylindrical surface forming a second rolling path,
   on the inside, a means for finely adjusting and assembling both left and right inner axisymmetrical parts,
a set of rolling members located between the first and second rolling paths.

Advantageously, the pulley described earlier may have the following characteristics:
the right inner axisymmetrical part and the left inner axisymmetrical part include recesses with which both a substantially toric optimum shape of the inside of the pulley may be provided while reducing the mass to a maximum,
right and left flanks extend the right and left inner axisymmetrical parts, respectively,
rolling members such as balls are placed on the lateral sides of the guide component,
the right and left flanks are in composite materials,
the right and left flanks comprise on a portion of their periphery, small holes so that a rope of small diameter may possibly be placed running from one flank to the other in order to prevent the main rope positioned in the groove of the pulley from being extracted from this groove,
the rolling members consist in balls or rollers made in ceramic,
the rolling and connecting ring is in titanium, coated with a titanium nitride layers
the rolling and connecting ring is in ceramic,
the guide component is in titanium,
two friction washers are respectively placed between the rollers and the flanks in order to maintain the rollers in position,
the means for finely adjusting and assembling both left and right inner axisymmetrical parts is formed by a threading positioned on the inside of the rolling and connecting ring and on the outside of the right and left inner axisymmetrical parts,
a lubricant material such as grease is placed in the recesses of the right and left inner parts so that these recesses are used as grease reservoirs,
recesses filled with grease are provided in the inner portion of the rollers so that when the pulley rotates, the centrifugal force drives the grease towards the rollers,
two washer-shaped and radially mounted side cleaning lips prevent outside dirt from perturbing proper operation of the rollers and prevent the grease from flowing out.

An embodiment of the invention will be described hereafter as a non-limiting example with reference to the appended drawings wherein:

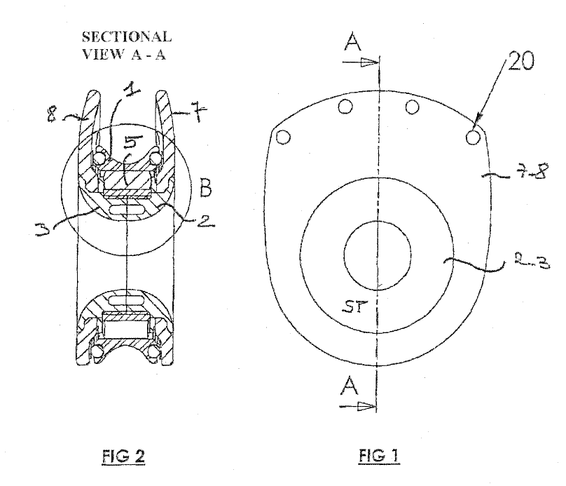

FIG. 1 is a side view of a pulley according to the invention.

FIG. 2 is an axial sectional view along A/A of FIG. 1.

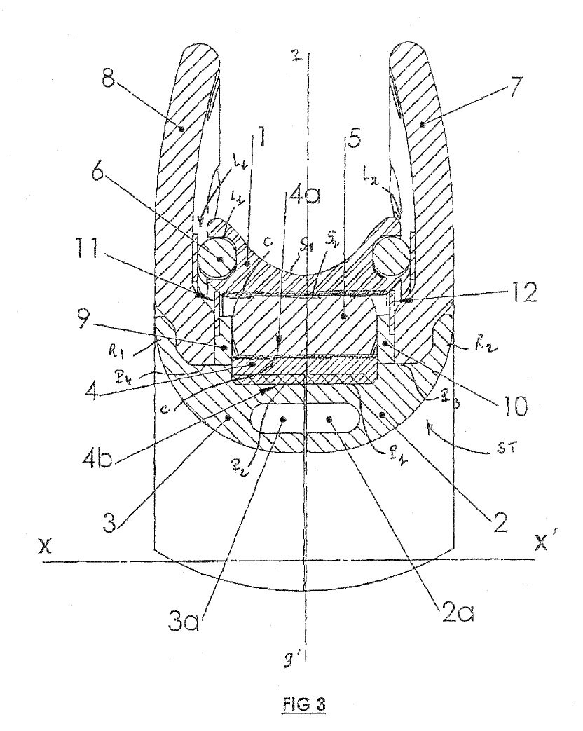

FIG. 3 is a partial view (half-sectional view) at a larger scale on FIG. 2.

In this example the pulley has a general toric shape. It comprises a rotary ring-shaped guide component (1) including:
an outer surface (S1) forming a flared groove intended to guide a rope.
a cylindrical inner surface (S2) comprising a first rolling path,
two side surfaces (L1, L2) which extend radially and each have a coaxial ring-shaped cavity with a partly cylindrical section in which balls 6 of the ball bearing are positioned.

This guide component 1 is rotatably mounted on a ring-shaped supporting structure (ST) made by assembling respectively both right (12) and left (3) inner axisymmetrical parts at the level of a radial plane (trace P, P′) which forms a plane of symmetry of the pulley.

This supporting structure (ST) has on the inner side, a toric surface with a semi-circular section and on the outer side, a staged cylindrical surface bordered by two protruding rims (R1, R2). The staged cylindrical surface comprises a threaded cylindrical central portion (P1, P2) and two cylindrical side portions (P3, P4) with a larger diameter at the central portion (P1, P2).

The assembly of both axisymmetrical parts (2, 3) which form the supporting structure is provided by a rolling and connecting ring (4) which comprises, on the outside, a cylindrical surface which forms a second rolling path 4a and on the inside a tapped cylindrical surface (4b), onto which both axisymmetrical parts (2, 3 will be screwed in at both threaded portions (P1, P2) which form the aforesaid central portion.

The advantage of this solution consists in that after having completed the screwing of both of the axisymmetrical parts (2, 3) on the rolling and connecting ring (4), accurate positioning of the assembly is obtained with respect to the radial plane (P, P′) of symmetry of the pulley.

In this example, both axisymmetrical parts (2, 3) each comprise a coaxial ring-shaped cavity (2a, 3a) which opens out into the axial plane of symmetry (P, P′). In the assembled position of both axisymmetrical parts (2, 3), these cavities (2a, 3a) delimit a scaled volume used for lightening the pulley and which may contain a lubricant used for lubrication of the bearings through lubrication conduits not shown.

Between the rolling paths (4a, S2), rollers (5) are positioned, with axes parallel to the axis of rotation (X, X′) of the guide component (1).

In this example, the rollers (5) are made in ceramic, for example in silicon nitride, a material which has a very large hardness, and which was not used up to now for this type of application.

The guide component (1) is, as for it, made in titanium, the rolling path (S2) being covered with a layer (C) in a harder material than titanium, here titanium nitride obtained by ion bombardment carried out with a processing gas comprising nitrogen or ammonia.

Also, the rolling and connecting ring may be made in titanium coated with a titanium nitride layer at the rolling path.

The use of a titanium/titanium nitride combination for the rolling paths (S2, 4a) and of a very hard ceramic for the rollers (5) has the following advantages:
the rollers do not deform under the effect of the stresses exerted on the pulley and therefore keep their rolling properties intact.
the bulk portions of the pulley are made in titanium and are therefore lightweight. By using a titanium nitride coating at the rolling paths (S1, 4a) it is possible to have a very hard layer hang a very good surface condition and which may have very good accuracy. The punching forces exerted by the rollers (5) on the rolling paths (S2, 4a) are distributed over a relatively large titanium area by the presence of a titanium nitride layer. Thus, the titanium nitride layer (C) is only subject to very slight elastic deformation which remains substantially tangential to the roller. The friction forces between the rollers (5) and the rolling paths (S2, 4a) are therefore reduced to a strict minimum. The same applies as regards wear.

In this example, the rims (R1, R2) of the axisymmetrical parts (3, 2) are each used for retaining a side flank ((7, 8) (or flange) in the form of a slightly curved curvilinear trapezium provided with a circular central orifice, the inner diameter of which is substantially equal to the diameter of the side portion (P3, P4) onto which it is engaged. These side flanks (7, 8) are used for maintaining the rope in the rotary guide component (1).

The thickness of these flanks (7, 9) is less than the length of the portion (P3, P4) so that between each flank (7, 8) and the rolling and connecting ring (4), there remains a space in which a spacer washer (9, 10) is positioned maintaining the rollers (5) in position. These washers (9, 10) which may be in bronze or in copper beryllium, delimit with the corresponding flanks 7, 8) grooves into which two washer-shaped and radially mounted side cleaning lips (11, 12) engage so as to prevent outside dirt from perturbing the operation of the rollers.

Advantageously, the ends of the rollers (5) have a spherical shape so that only one point of the rollers (5) is in contact with the side washers (10). Consequently, the rollers (5) may slightly tilt without notably increasing friction between the rollers and the washers.

Moreover, the flanks are provided, at their faces facing each other, with a rolling path in a hard material on which the balls (6) will be supported so as to maintain the rotary guide component (1) laterally.

According to the invention, the rolling paths (S2 and 4a) are coated with a layer in a harder material than that of the guide component (1) and of the rolling and guiding ring (4). Thus, in the case when the guide component (1) and the ring of (4) are made in titanium, the harder material layer may consist in titanium nitride made by a treatment of the Chemical Vapor Deposition (CVD) type or even of the Plasma Assisted Chemical Vapor Deposition (PACVD) type.

This layer may be obtained by a treatment of the Physical Vapor Deposition (PVD) type by ion bombardment. Nevertheless other surface treatments of titanium are possible such as for example a BVB type treatment at a high or low temperature.

Of course, the invention is not limited to the embodiment described earlier. Thus:
the right and left side flanks may be made in composite materials and comprise on a portion of their periphery small holes so that a rope of small diameter may possibly be placed running from one plane to the other in order to prevent the main rope positioned in the groove of the pulley from being extracted from this groove,
the rolling members may consist in ceramic or titanium balls coated with titanium nitride,
the rolling and connecting ring may be at least partly made in ceramic,
recesses filled with grease may be provided in the inner portion of the rollers so that when the pulley rotates, the centrifugal force drives the grease towards the rollers.

The mounting of the pulley may be carried as follows:
the right flank (7) is pre-positioned in the right inner axisymmetrical part (2) and the spacer washer (10) is then positioned in this same right inner axisymmetrical part (2),
left flank (9) is propositioned in the left inner axisymmetrical part (3) and the spacer washer (9) and the lip (11) are then positioned in this same left inner axisymmetrical part (3),
the balls (6) are placed in the lateral sides of the guide component (1),
one of the two axisymmetrical parts (2, 3) is screwed onto the rolling and connecting ring (4),
the guide component (1) is engaged coaxially with the rolling ring 4 and the rollers (5) are then positioned in the space between both rolling paths (S2 and 4a),
the second axisymmetrical part is screwed onto the rolling and connecting ring (4). By more or less screwing the right and left lower portions onto the rolling and connecting ring (4), it is possible to finely adjust the side tolerances of the assembly and notably the side plays of the rollers relatively to the spacer washers.

Operating of the device described earlier is carried out in the following way:

One strap is passed through the central orifice of the pulley. With the rounded shape of the inside of the supporting structure (ST), it is not possible to damage this strap and friction existing between this strap and the inside of the pulley mays be minimized.

A rope is placed into the groove of the guide component (1).

The assembly is ready to be used.

As mentioned earlier, this device according to the invention is very suitable for making a pulley for sailing boats. However, this device finds many different applications in various fields or may be used in systems which have to include performing pulleys with low mass and low bulkiness.

1. A rolling/bearing device involving two parts rotationally mobile relatively to each other with interposition of rolling members bearing on rolling paths facing both parts with support which is exerted at respective contact surfaces of said paths and said rolling members,
wherein at least one of said contact surfaces bears a layer in a harder and more resistant material than the underlying substrate which supports it.

2. The rolling/bearing device according to claim 1, wherein the substrate bearing the aforesaid layer is made in titanium whereas the layer is itself made in titanium nitride.

3. The rolling/bearing device according to claim 2, wherein the aforesaid layer is obtained by physical vapor deposition.

4. The rolling/bearing device according to claim 2, wherein the aforesaid layer is made by chemical vapor deposition.

5. The rolling/bearing device according to claim 2, wherein the aforesaid layer is made by plasma-assisted chemical vapor deposition.

6. The rolling/bearing device according to claim 1, wherein said rolling members consist in balls or rollers.

7. The rolling/bearing device according to claim 6, wherein said balls or said roller are made in a ceramic such as silicon nitride.

8. The rolling/bearing device according to claim 6, wherein said rollers are laterally maintained by two side washers in a material such as bronze or copper beryllium.

9. The rolling/bearing device according to claim 8, wherein said the rollers have spherical ends.

10. The rolling/bearing device according to claim 1 which constitutes a pulley comprising:
a guide component having an axisymmetrical shape and including an outer groove intended to guide a rope and an inner surface comprising a first rolling path,
a ring-shaped supporting structure on which the guide component is rotatably mounted, this supporting structure being made by assembling two respectively right and left coaxial inner axisymmetrical parts,
a rolling and connecting ring comprising:
on the outside, a cylindrical axisymmetrical surface forming a second rolling path,
on the inside, a means for finely adjusting and assembling both left and right inner axisymmetrical paths,
a set of rolling members located between the first and second rolling path.

11. The rolling/bearing device according to claim 10, wherein said right inner axisymmetrical part and said left inner axisymmetrical part include recesses.

12. The rolling/bearing device according to claim 10,
having right and left flanks which extend the right and left inner axisymmetrical parts, respectively.

13. The rolling/bearing device according to claim 10, which comprises rolling members such as balls placed on the lateral sides of the guide component.

14. The rolling/bearing device according to claim 10, wherein said wherein said right and left flanks are in composite materials.

15. The rolling/bearing device according to claim 12, wherein said right and left flanks comprise on a portion of their periphery, small holes so that a rope of small diameter may possibly be placed running from one flank to the other.

16. The rolling/bearing device according to claim 10, wherein said rolling members consist in balls or rollers made in ceramic.

17. The rolling/bearing device according to claim 10, wherein said means for finely adjusting and assembling both left and right inner axisymmetrical parts is formed by a threading positioned on the inside of the rolling and connecting ring and on the outside of the right and left inner axisymmetrical parts.

18. The rolling/bearing device according to claim 10, which comprises a lubricant material such as grease placed in the recesses of the right and left inner parts.

19. The rolling/bearing device according to claim 10, which comprises both washer-shaped and radially mounted side cleaning lips which prevent outside dirt from perturbing proper operation of the rollers and which prevent the grease from flowing out.
